(19) United States
(12) Patent Application Publication
(10) Pub. No.: US 2013/0010403 A1
(43) Pub. Date: Jan. 10, 2013

(54) ELECTROLYTIC MATERIAL FORMULATION, ELECTROLYTIC MATERIAL COMPOSITION FORMED THEREFROM AND USE THEREOF

(75) Inventors: Shinn-Horng Chen, Kaohsiung (TW); Chieh-Fu Lin, Taipei (TW)

(73) Assignees: Gemmy Electronic Co., Ltd.; Eternal Chemical Co., Ltd.

(21) Appl. No.: 13/540,721

(22) Filed: Jul. 3, 2012

(30) Foreign Application Priority Data
Jul. 8, 2011 (TW) 100124390

(51) Int. Cl. H01G 9/025; H01G 9/022

(52) U.S. Cl. 361/525; 252/62.2

(57) ABSTRACT

An electrolytic material formulation is provided, which comprises: (a1) a conductive compound, (b1) an oxidant and (c1) a polymerizable component. An electrolytic material composition obtained from the electrolytic material formulation through polymerization is also provided. The electrolytic material composition is applicable to a solid capacitor. Compared to a conventional liquid electrolytic capacitor, the solid electrolyte capacitor according to the present invention has advantages of long life, high voltage resistance, high capacitance, and no occurrence of capacitor rupture, and is especially applicable to electronic products that require high temperature resistance and high frequency resistance.

### BACKGROUND OF THE INVENTION

1. Field of the Invention

The present invention relates to an electrolytic material formulation, an electrolytic material composition formed from the electrolytic material formulation, and a solid capacitor using the electrolytic material composition.

2. Description of the Related Art

Capacitors are a type of electronic elements that are widely used in various electronic products. With advancement in technology development, electronic products are being developed in the direction of miniaturization and light weight, and the capacitors used in electronic products are required to be miniaturized and have a high capacitance and a low impedance when being used at a high frequency.

Capacitors may be classified into conventional liquid capacitors and newly developed solid capacitors. In the electrolyte of early-stage aluminum liquid capacitor, a liquid electrolyte is used as a charge transfer substance. The main components of the liquid electrolyte include a high-boiling point alcohol, an ionic liquid, boric acid, phosphoric acid, an organic carboxylic acid, an ammonium, a high-polarity organic solvent, and a small amount of water. The components not only serve as charge transfer substances, but also have the function of patching a dielectric layer of aluminum oxide on an aluminum foil. If the internal aluminum metal is exposed due to defects on the dielectric layer of aluminum oxide, during the charge and discharge process of the capacitor, the electrolyte may react with the exposed aluminum metal and aluminum oxide is generated, thus achieving the patching function. However, although the conventional aluminum liquid capacitor can meet the requirement of high capacitance at a low cost, as the electrolyte used is a liquid, it has the disadvantages of low conductivity and poor high temperature resistance; moreover, in the process of aluminum oxide generation, hydrogen is also generated, and if excessive hydrogen is accumulated in the capacitor, capacitor rupture can easily occur, which will damage the electronic product. Although a hydrogen absorbing agent may be added to the liquid electrolyte to reduce the risk of capacity rupture, the problem is not eliminated.

Accordingly, a new generation of solid capacitor is developed, in which the liquid electrolyte is directly replaced by a solid electrolyte. The solid electrolyte is formed by a conductive polymer. Anions of an oxidant are blended in the structure of the polymer as a dopant and holes are formed, so that the polymer has conductivity. Compared with the liquid electrolyte or a solid organic semiconductor complex salt such as tetracyanoquinodimethane (TCNQ) composite salt and inorganic semiconductor MnO₂ used in conventional electrolyte capacitor, the conductive polymer has a high conductivity and a suitable high high-temperature insulation property, so the conductive polymer has propelled the development of the trend of using solid electrolyte in current electrolytic capacitors.

In addition to having long service life that is 6 times longer than that of a common capacitor, the solid capacitor has improved stability and its capacitance is not easily influenced by an ambient temperature and humidity in use. Additionally, the solid capacitor has the advantage of a low ESR, a low capacitance variation rate, an excellent frequency response (high frequency resistance), a high temperature resistance, and a high current resistance, and the problem of leakage and plasma explosion is eliminated. Although conventional liquid capacitor has high capacitance, its application is limited due to a high ESR.

Jesse S. Shaffer et al disclose a method of using a conductive polymer in an electrolyte of an electrolytic capacitor for the first time in U.S. Pat. No. 4,609,971. The method includes immersing an anode aluminum foil of a capacitor in a mixture solution formed by a conductive polymer polyaniline powder and a dopant LiClO₄, and then removing a solvent on the aluminum foil. Due to its excessively high molecular weight, polyaniline cannot permeate into micropores of the anode foil, so the impregnation rate of the capacitor obtained through this method is poor, and the impedance is high. Then, in order to enable the polymer to easily permeate into the micropores of the anode foil, Gerhard Hellwig et al disclose a chemical oxidation polymerization method of using a conductive polymer as an electrolyte of a capacitor in U.S. Pat. No. 4,803,596. The method includes respectively immersing a capacitor anode foil in a solution of a conductive polymer monomer and an oxidant, and polymerizing the conductive polymer monomer at a suitable condition, in which the conductive polymer electrolyte is accumulated to a sufficient thickness through multiple immersions. Thereafter, Friedrich Jonas et al of the Bayer Corporation in Germany disclose a method of manufacturing an aluminum solid capacitor with poly-3,4-ethylenedioxythiophene (PEDOT) as an electrolyte by using a monomer 3,4-ethylenedioxythiophene (EDOT) in combination with an oxidant iron (III) p-toluenesulfonate for the first time in U.S. Pat. No. 4,910,645. The conductive polymer PEDOT has the advantages of a high heat resistance, a high conductivity, a high charge transfer velocity, being non-toxic, a long service life, and no occurrence of capacitor rupture when being applied in a capacitor. Presently, almost all solid capacitor manufacturers use the two materials to manufacture aluminum or tantalum solid capacitor. However, PEDOT on the aluminum foil surface or pores that is polymerized by immersing the capacitor element in a mixture solution containing the monomer EDOT and iron (III) p-toluenesulfonate mostly has a powder structure, and the physical properties of the powder structure are poor, so the powder structure cannot be easily adhered on the aluminum foil surface or pores as it is more likely to fall off from the surface or pores, and a complete PEDOT polymer structure cannot be easily formed on the aluminum foil surface or pores. Therefore, the stability of the solid capacitor at a voltage of 16 V or higher is poor, resulting in that the solid capacitor cannot be used in the process of a voltage of 16 V or higher, or the yield of the process is low. Moreover, since the powder structure formed by the conductive polymer PEDOT cannot be easily adhered on the aluminum foil pores, when the problem of falling off occurs, the withstandable working voltage is limited.

In Japanese Patent No. 2010129651, it is disclosed that a capacitor element is directly immersed in a polymer solution containing a polymer PEDOT, and a complete PEDOT polymer structure is formed on an aluminum foil surface or pores, so that a solid capacitor is applicable in a working environment of a voltage of 50 V. However, when compared with conventional process, the cost of the polymer PEDOT material is higher than that of the monomer EDOT; the polymer PEDOT material is difficult to store; and the process needs more time and is more difficult to control.

Accordingly, the industry calls for the development of a solid capacitor that can withstand a high voltage, has good stability and is priced at a relatively low cost, so as to replace the liquid capacitor in 3C products that require high temperature resistance and high frequency resistance.

### SUMMARY OF THE INVENTION

Accordingly, the present invention is directed to an electrolytic material formulation, which comprises:

(a1) a conductive compound;

(b1) an oxidant; and

(c1) a polymerizable compound.

The present invention is further directed to an electrolytic material composition formed from the electrolytic material formulation of the present invention through polymerization, which is applicable to a solid capacitor.

The present invention is yet further directed to a solid capacitor, which comprises an anode; a dielectric layer formed on the anode; a cathode; and a solid electrolyte located between the dielectric layer and the cathode, in which the solid electrolyte comprises the electrolytic material composition according to the present invention.

The solid capacitor manufactured from the electrolytic material formulation according to the present invention has the advantages of easy construction, low cost, good process stability, high voltage resistance, high capacitance, and low impedance.

### BRIEF DESCRIPTION OF THE DRAWING

FIG. 1 shows a capacitor element according to an embodiment of the present invention.

### DETAILED DESCRIPTION OF THE INVENTION

The electrolytic material formulation according to the present invention comprises: (a1) a conductive compound; (b1) an oxidant; and (c1) a polymerizable compound.

The conductive compound used in the present invention is generally a monomer, an oligomer, or a combination thereof. The conductive compounds useful in the present invention are known in the art, and for example, can be selected from the group consisting of pyrrole, thiophene, aniline, and phenylene sulfide, and derivatives thereof.

The oxidant used in the present invention may form a conductive polymer in conjunction with the conductive compound. The oxidants useful in the present invention are known in the art, and for example, can be selected from the group consisting of alkali metal persulfates, ammonium salts, ferric salts of organic acids, and inorganic acids with an organic group. According to a specific embodiment of the present invention, the oxidant can be selected from the group consisting of iron (III) p-toluenesulphonate, ammonium sulfate, ammonium persulfate, ammonium oxalate, and ammonium perchlorate, and mixtures thereof, with iron (III) p-toluenesulfonate being preferred.

The polymerizable compound in the electrolytic material formulation of the present invention is generally a monomer, an oligomer, or a combination thereof, and the molecular weight of the polymerizable compound is preferably in the range of 40 to 1,000,000.

In the electrolytic material formulation of the present invention, based on 100 parts by weight of the component (a1), the amount of the component (b1) is 1-10000 parts by weight, and the amount of the component (c1) is 0.1-10000 parts by weight. Preferably, based on 100 parts by weight of the component (a1), the amount of the component (b1) is 10-2000 parts by weight, and the amount of the component (c1) is 1-3000 parts by weight.

The polymerizable compound used in the electrolytic material formulation of the present invention may be an epoxy group-containing polymerizable compound, vinyl-containing unsaturated polymerizable compound, acrylate-containing unsaturated polymerizable compound, or a mixture thereof, and preferably, the polymerizable compound is selected from the group consisting of:

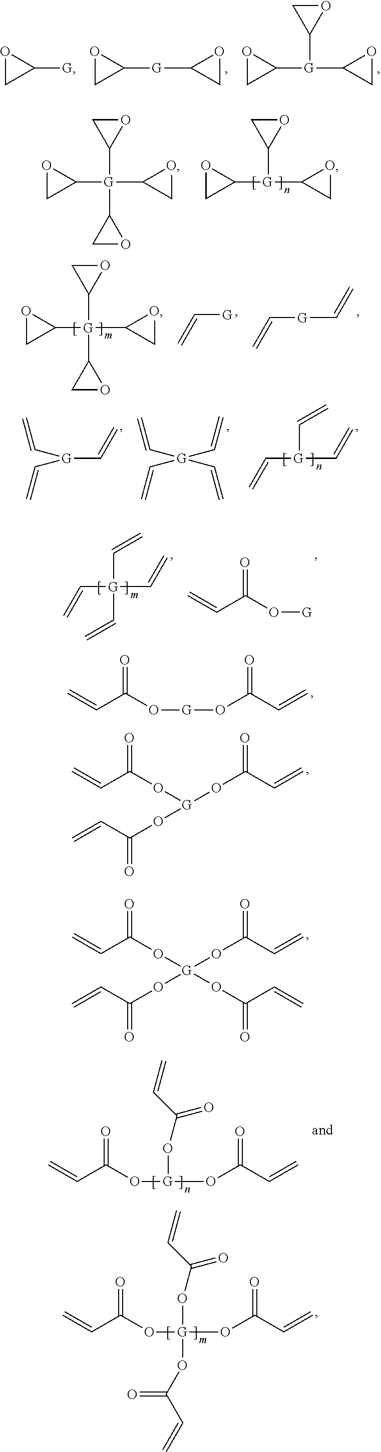

where n is an integer greater than or equal to 3, m is an integer greater than or equal to 2, and G is an organic group, an inorganic group, or a mixture thereof.

According to an embodiment of the present invention, the polymerizable compound is selected from the group consisting of:

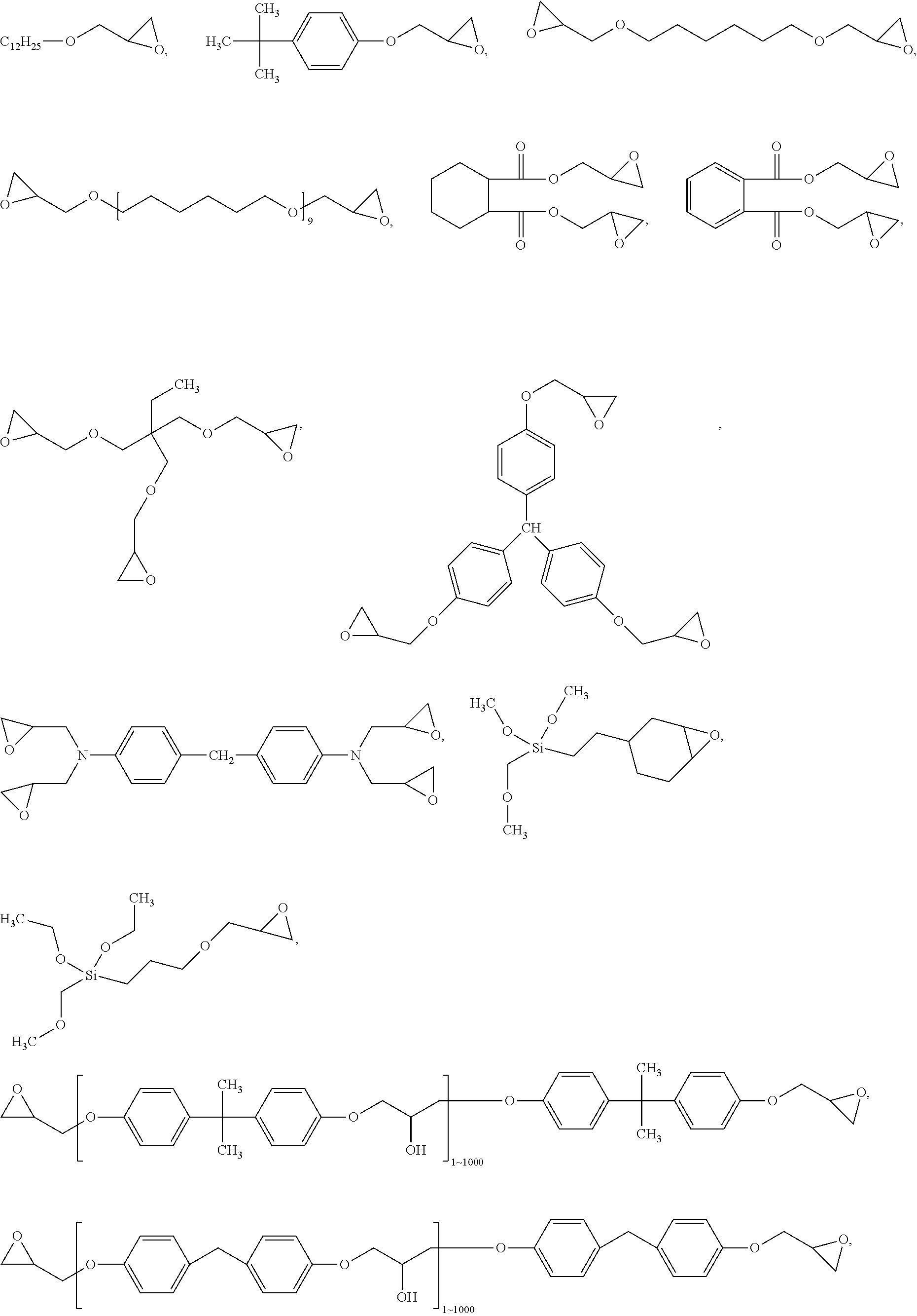

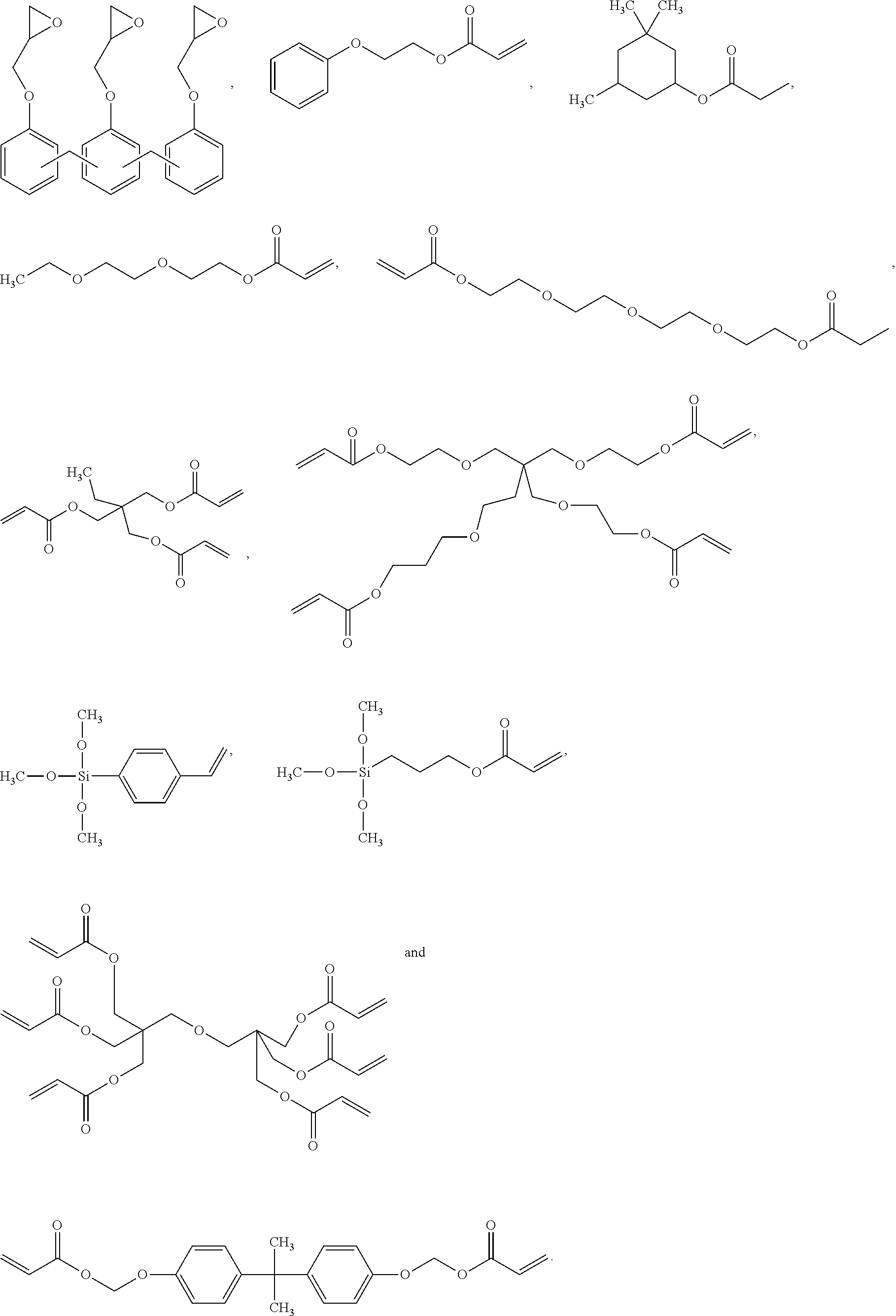

The electrolytic material formulation of the present invention can optionally comprise a curing agent. For example, when an epoxy group-containing polymerizable compound is used, a curing agent is added, and upon crosslinking and curing, a three-dimensional network structure is formed. The curing agent useful in the present invention is known in the art, and for example, can be an amine or an acid anhydride, such as,

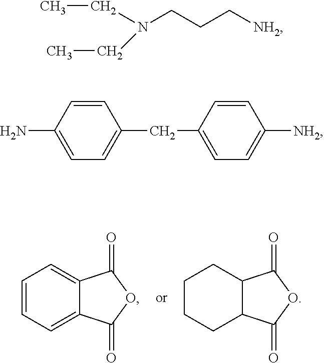

According to the present invention, the curing agent is used in an amount such that a weight ratio to a curable component is 0 to 2, and preferably 0 to 1.5.

In order to accelerate the curing reaction, the electrolytic material formulation of the present invention may further comprise a catalyst. The catalyst useful in the present invention is known in the art, which for example, can be a tertiary amine, an azo compound, or a benzoyl compound, such as,

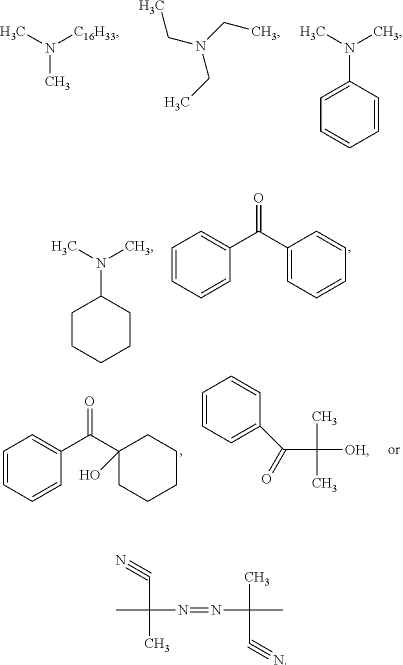

According to the present invention, the catalyst is used in an amount such that a weight ratio to the curable component is 0.001 to 1, preferably 0.005 to 0.5, and most preferably 0.01 to 0.25.

The present invention also provides an electrolytic material composition formed from the electrolytic material formulation through polymerization, which comprises:

(A) a first polymer, formed from the polymerization units derived from the conductive compound and the oxidant; and

(B) a second polymer, formed from the polymerization units derived from the polymerizable compound.

The conductive polymer used in conventional solid electrolyte cannot form a complete structure of a conductive polymer, the stability is poor, and the yield of the process is low, because the formed powder-like structure is not easy to be adhered on an anode foil surface or pores but likely to fall off from the surface or pores. The electrolytic material composition of the present invention contains the first polymer and the second polymer, and the first polymer and the second polymer do not react with each other. The first polymer is used as a conductive polymer and exhibits the characteristics of high heat resistance, high conductivity, high charge transfer velocity, being non-toxic, a long service life, and no occurrence of capacitor rupture when being applied in a capacitor. The second polymer is used as a polymerizable material, and in order to increase the degree of crosslinking of molecules in polymerization and enable the second polymer to be cured, the second polymer is optionally formed from the polymerization units derived from a polymerizable compound and a curing agent. The network structure of the second polymer will form a thin film to improve the stability of the first polymer, so that the first polymer can be adhered on a capacitor element without falling off, and is applicable in a high-voltage (a voltage of 16 V or higher) working environment, preferably a working environment of a voltage of 50 V or higher. Moreover, it can be found from a capacitor long-term efficacy test that the variation of the capacitance is very little. Therefore, the solid capacitor manufactured from the electrolytic material composition of the present invention has long-term efficacy.

The electrolytic material formulation of the present invention is polymerized in a capacitor, and the process pertains to an in situ reaction. The in situ process may be classified into a one-solution method, a two-solution method, and a multiple-solution method. For example, the electrolytic material formulation of the present invention is formulated into a single solution, or formulated into two solutions including a first solution and a second solution. The first solution contains (a1) the conductive compound and (c1) the polymerizable compound of the electrolytic material formulation, and the second solution contains (b1) the oxidant of the electrolytic material formulation. Or, the electrolytic material formulation of the present invention is formulated into multiple solutions including a first solution, a second solution, and a third solution. The first solution contains (a1) the conductive compound of the electrolytic material formulation, the second solution contains (b1) the oxidant of the electrolytic material formulation, and the third solution contains (c1) the polymerizable compound of the electrolytic material formulation. Regardless of the one-solution method, the two-solution method, or the multiple-solution method, a curing agent and a catalyst may be optionally added, where the curing agent and the catalyst are as defined above. In order to adjust the viscosity of the solution, the electrolytic material formulation of the present invention may further contain a solvent. The solvent useful in the present invention is not particularly limited in principle, which for example, can be selected from the group consisting of water, alcohols, benzenes, and combinations thereof, preferably selected from the group consisting of methanol, ethanol, propanol, n-butanol, tert-butanol, water, and combinations thereof.

The present invention further provides a solid capacitor, comprising: an anode; a dielectric layer formed on the anode; a cathode; and a solid electrolyte located between the dielectric layer and the cathode, wherein the solid electrolyte comprises the electrolytic material composition mentioned above. The solid capacitor may be an aluminum solid capacitor, a tantalum solid capacitor, or a niobium solid capacitor. Specifically, as the main part of the solid capacitor, the anode is formed by, with an etched conductive metal foil as an anode foil, performing anode oxidation processing on a surface of the anode foil and introducing a wire from the anode foil, and the cathode is formed by, with a metal foil as a cathode foil, introducing a wire from the cathode foil. The dielectric layer is formed from an oxide or the like and is formed on the surface of the anode foil, and is located between the anode foil and the cathode foil. The anode foil and the cathode foil are formed from aluminum, tantalum, niobium, aluminum oxide, tantalum oxide, niobium oxide, titanium plated aluminum, or carbon plated aluminum. The anode foil and the cathode foil are wound into a cylinder, and immersed in the electrolytic material formulation in the form of a solution, and after curing treatment (for example, thermal polymerization), a solid electrolyte is formed between the dielectric layer and the cathode foil of the solid capacitor.

After the solid electrolyte is formed in the capacitor element, a solid capacitor may be formed by using conventional technologies and materials. For example, the capacitor element may be installed in a box with a bottom, and a seal element with an opening for exposing the wires may be disposed at the top of the box, and a solid capacitor may be formed after being sealed. The solid capacitor manufactured from the electrolytic material formulation of the present invention exhibits the advantages of easy construction, low cost, good process stability, high voltage resistance (50 V or higher), high capacitance, and low impedance (20 mΩ or lower).

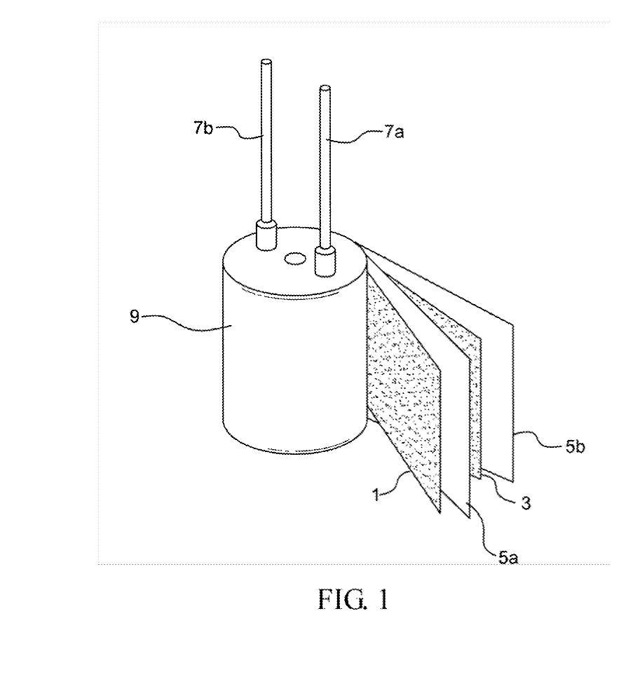

In the following, methods for manufacturing an electrolytic material composition and a solid capacitor according to an embodiment of the present invention are described with reference to FIG. 1.

FIG. 1 shows a capacitor element according to an embodiment of the present invention. As shown in FIG. 1, an anode foil 1 and a cathode foil 3 and spacer components 5a and 5b that are inserted between the anode foil 1 and the cathode foil 3 are wound together to form a capacitor element 9. Wires 7a and 7b serve as terminals for connecting the cathode foil 3 and the anode foil 1 to an external circuit.

The number of wires connected to the cathode foil and the anode foil is not particularly limited, provided that the cathode foil and the anode foil both are wire connected. The number of the cathode foils and the anode foils is not particularly limited, and for example, the number of the cathode foils may be the same as that of the anode foils, or the number of the cathode foils may be greater than that of the anode foils. The dielectric layer (not shown) formed from an oxide or the like is formed on the surface of the anode foil, and is located between the anode foil and the cathode foil. The anode foil 1, the cathode foil 3, the spacer components 5a and 5b, and the wires 7a and 7b are manufactured by using known materials through known technologies.

Next, the capacitor element is immersed in the electrolytic material formulation in the form of a solution so that a solid electrolyte is formed between the dielectric layer and the cathode foil of the solid capacitor.

The method for forming the solid electrolyte includes, first, as described above, formulating the electrolytic material formulation into a single solution or multiple solutions. If the electrolytic material formulation is formulated into a single solution, the capacitor element 9 is directly immersed in the solution of the electrolytic material formulation; and if the electrolytic material formulation is formulated into two solutions as mentioned above, the capacitor element 9 may be first immersed in the first solution and then immersed in the second solution, or the capacitor element 9 may be first immersed in the second solution and then immersed in the first solution, and thereafter stays in an environment with a temperature of 25° C. to 260° C. for a period of time, for example, 1 to 12 hr, preferably 1 to 5 hr, during which time, the conductive compound first reacts with the oxidant to form a conductive polymer. Preferably, the temperature is 85° C. to 160° C.

Next, the polymerizable compound is subjected to curing treatment (for example, heat treatment) to form a polymerizable material, and optionally, a curing agent, or catalyst, or a mixture thereof is added in the heat treatment process.

In this way, an electrolytic material composition containing the conductive polymer and the polymerizable material is formed between the dielectric layer of the anode foil and the cathode foil.

The electrolytic material composition containing the conductive polymer and the polymerizable material is formed From the electrolytic material formulation of the present invention upon heat treatment. The polymerizable material can enhance the stability of the structure of the conductive polymer and prevent the anode from being stricken through by leakage current, thereby avoiding short circuit of the solid capacitor. Therefore, the polymerizable material can improve the voltage resistance of the solid capacitor, and can improve the adhesion property of the conductive polymer, so a complete structure of the conductive polymer can be formed on an electrode surface or pores of the metal foil, and can withstand a high voltage and has a high capacitance.

The present invention will be further described by the following examples.

### EXAMPLES

### Example 1

As shown in FIG. 1, a capacitor element 9 was immersed in an electrolytic material formulation formed by mixing 30 g 3,4-ethylenedioxythiophene, 100 g ethanol solution containing 40% iron (III) p-toluenesulphonate, 20 g polymerizable compound

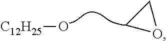

20 g curing agent

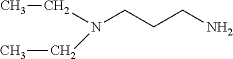

and 2 g catalyst

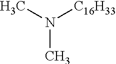

for 5 min. Then, the capacitor element was taken out from the electrolytic material formulation, and subjected to heat polymerization at a temperature in the range of 25° C. to 260° C., so as to form a solid electrolyte containing a mixture of a conductive polymer and a polymerizable material.

The capacitor element having the solid electrolyte was disposed in a box with a bottom, and the box was sealed with a seal element formed by an elastic substance with wires exposed, thus forming a solid capacitor.

Electrical data for the solid capacitor manufactured through the above process is shown in Table 1 below.

### Example 2

As shown in FIG. 1, a capacitor element 9 was first immersed in a first solution formed by mixing 30 g 3,4-ethylenedioxythiophene, 15 g polymerizable compound

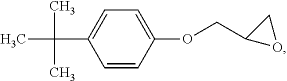

20 g curing agent

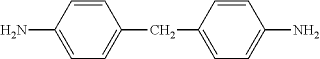 [SMILES: Nc1ccc(Cc2ccc(N)cc2)cc1]

and 2 g catalyst

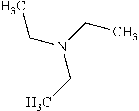

for 5 min, and then immersed in a second solution of 100 g n-butanol solution containing 45% iron (III) p-toluenesulfonate for 5 min. Then, the capacitor element was taken out from the electrolytic material formulation, and subjected to heat polymerization at a temperature in the range of 25° C. to 260° C., so as to form a solid electrolyte containing a mixture of a conductive polymer and a polymerizable material.

The capacitor element having the solid electrolyte was disposed in a box with a bottom, and the box was sealed with a seal element formed by an elastic substance with wires exposed, thus forming a solid capacitor.

Electrical data for the solid capacitor manufactured through the above process is shown in Table 1 below.

### Example 3

As shown in FIG. 1, a capacitor element 9 was first immersed in a second solution of 100 g tert-butanol solution containing 50% iron (III) p-toluenesulphonate for 5 min, and then immersed in a first solution formed by mixing 30 g 3,4-ethylenedioxythiophene, 15 g polymerizable compound

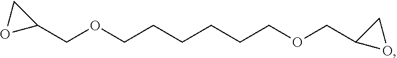 [SMILES: C(CCCOCC1CO1)CCOCC1CO1]

15 g curing agent

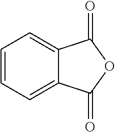 [SMILES: O=C1OC(=O)c2ccccc21]

and 2 g catalyst

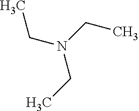

for 5 min. Then, the capacitor element was taken from the electrolytic material formulation, and subjected to heat polymerization at a temperature in the range of 25° C. to 260° C., so as to form a solid electrolyte containing a mixture of a conductive polymer and a polymerizable material.

The capacitor element having the solid electrolyte was disposed in a box with a bottom, and the box was sealed with a seal element formed by an elastic substance with wires exposed, thus forming a solid capacitor.

Electrical data for the solid capacitor manufactured through the above process is shown in Table 1 below.

### Example 4

As shown in FIG. 1, a capacitor element 9 was first immersed in a first solution containing 30 g 3,4-ethylenedioxythiophene for 5 min, and then immersed in a second solution formed by mixing 100 g tert-butanol solution containing 50% iron (III) p-toluenesulfonate, 20 g polymerizable compound

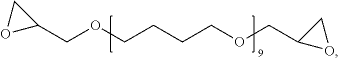

20 g curing agent

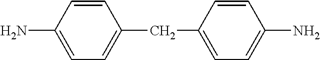 [SMILES: Nc1ccc(Cc2ccc(N)cc2)cc1]

and 2 g catalyst

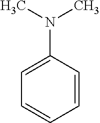

for 5 min. The capacitor element was taken from the electrolytic material formulation, and subjected to heat polymerization at a temperature in the range of 25° C. to 260° C., so as to form a solid electrolyte containing a mixture of a conductive polymer and a polymerizable material.

The capacitor element having the solid electrolyte was disposed in a box with a bottom, and the box was sealed with a seal element formed by an elastic substance with wires exposed, thus forming a solid capacitor.

Electrical data for the solid capacitor manufactured through the above process is shown in Table 1 below.

### Example 5

As shown in FIG. 1, a capacitor element 9 was first immersed in a second solution formed by mixing 100 g ethanol solution containing 55% iron (III) p-toluenesulphonate, 20 g polymerizable compound

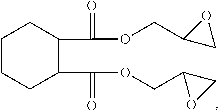 [SMILES: O=C(OCC1CO1)C1CCCCC1C(=O)OCC1CO1]

20 g curing agent

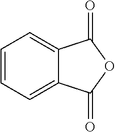 [SMILES: O=C1OC(=O)c2ccccc21]

and 2 g catalyst

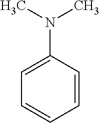

for 5 min, and then immersed in a first solution containing 30 g 3,4-ethylenedioxythiophene for 5 min. Then, the capacitor element was taken from the electrolytic material formulation, and subjected to heat polymerization at a temperature in the range of 25° C. to 260° C., so as to form a solid electrolyte containing a mixture of a conductive polymer and a polymerizable material.

The capacitor element having the solid electrolyte was disposed in a box with a bottom, and the box was sealed with a seal element formed by an elastic substance with wires exposed, thus forming a solid capacitor.

Electrical data for the solid capacitor manufactured through the above process is shown in Table 1 below.

### Example 6

As shown in FIG. 1, a capacitor element 9 was immersed in an electrolytic material formulation formed by mixing 40 g pyrrole, 120 g propanol solution containing 40% iron (III) p-toluenesulfonate, 50 g polymerizable compound

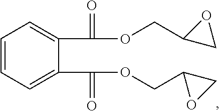 [SMILES: O=C(OCC1CO1)c1ccccc1C(=O)OCC1CO1]

50 g curing agent

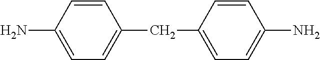 [SMILES: Nc1ccc(Cc2ccc(N)cc2)cc1]

and 5 g catalyst

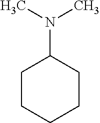

for 5 min. Then, the capacitor element was taken from the electrolytic material formulation, and subjected to heat polymerization at a temperature in the range of 25° C. to 260° C., so as to form a solid electrolyte containing a mixture of a conductive polymer and a polymerizable material.

The capacitor element having the solid electrolyte was disposed in a box with a bottom, and the box was sealed with a seal element formed by an elastic substance with wires exposed, thus forming a solid capacitor.

Electrical data for the solid capacitor manufactured through the above process is shown in Table 1 below.

### Example 7

As shown in FIG. 1, a capacitor element 9 was immersed in an electrolytic material formulation formed by mixing 40 g aniline, 120 g ethanol solution containing 40% iron (III) p-toluenesulphonate, 40 g polymerizable compound

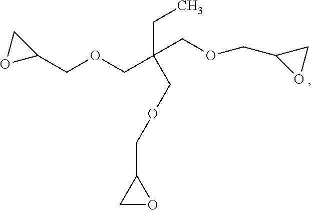 [SMILES: CCC(COCC1CO1)(COCC1CO1)COCC1CO1]

40 g curing agent

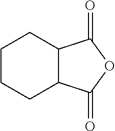 [SMILES: O=C1OC(=O)C2CCCCC12]

and 5 g catalyst

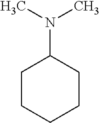

for 5 min. Then, the capacitor element was taken from the electrolytic material formulation, and subjected to heat polymerization at a temperature in the range of 25° C. to 260° C., so as to form a solid electrolyte containing a mixture of polymers of a conductive polymer and a polymerizable material.

The capacitor element having the solid electrolyte was disposed in a box with a bottom, and the box was sealed with a seal element formed by an elastic substance with wires exposed, thus forming a solid capacitor.

Electrical data for the solid capacitor manufactured through the above process is shown in Table 1 below.

### Example 8

As shown in FIG. 1, a capacitor element 9 was immersed in an electrolytic material formulation formed by mixing 30 g 3,4-ethylenedioxythiophene, 100 g tert-butanol solution containing 40% iron (III) p-toluenesulfonate, 20 g polymerizable compound

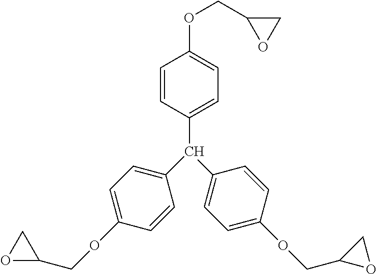 [SMILES: c1cc(C(c2ccc(OCC3CO3)cc2)c2ccc(OCC3CO3)cc2)ccc1OCC1CO1]

and 20 g curing agent

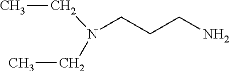

for 5 min. Then, the capacitor element was taken from the electrolytic material formulation, and subjected to heat polymerization at a temperature in the range of 25° C. to 260° C., so as to form a solid electrolyte containing a mixture of a conductive polymer and a polymerizable material.

The capacitor element having the solid electrolyte was disposed in a box with a bottom, and the box was sealed with a seal element formed by an elastic substance with wires exposed, thus forming a solid capacitor.

Electrical data for the solid capacitor manufactured through the above process is shown in Table 1 below.

### Example 9

As shown in FIG. 1, a capacitor element 9 was first immersed in a first solution formed by mixing 30 g 95% ethanol diluted 3,4-ethylenedioxythiophene, 15 g polymerizable compound

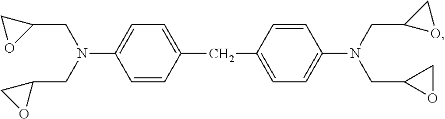 [SMILES: c1cc(N(CC2CO2)CC2CO2)ccc1Cc1ccc(N(CC2CO2)CC2CO2)cc1]

15 g curing agent

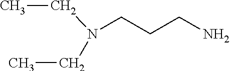

and 2 g catalyst

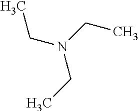

for 5 min, and then immersed in a second solution of 100 g n-butanol solution containing 45% iron (III) p-toluenesulphonate for 5 min. Then, the capacitor element was taken from the electrolytic material formulation, and subjected to heat polymerization at a temperature in the range of 25° C. to 260° C., so as to form a solid electrolyte containing a mixture of a conductive polymer and a polymerizable material.

The capacitor element having the solid electrolyte was disposed in a box with a bottom, and the box was sealed with a seal element formed by an elastic substance with wires exposed, thus forming a solid capacitor.

Electrical data for the solid capacitor manufactured through the above process is shown in Table 1 below.

### Example 10

As shown in FIG. 1, a capacitor element 9 was immersed in an electrolytic material formulation formed by mixing 30 g 3,4-ethylenedioxythiophene, 150 g tert-butanol solution containing 40% iron (III) p-toluenesulfonate and 20 g polymerizable compound

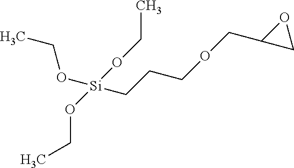 [SMILES: CCO[Si](CCCOCC1CO1)(OCC)OCC]

for 5 min. Then, the capacitor element was taken from the electrolytic material formulation, and subjected to heat polymerization at a temperature in the range of 25° C. to 260° C., so as to form a solid electrolyte containing a mixture of a conductive polymer and a polymerizable material.

The capacitor element having the solid electrolyte was disposed in a box with a bottom, and the box was sealed with a seal element formed by an elastic substance with wires exposed, thus forming a solid capacitor.

Electrical data for the solid capacitor manufactured through the above process is shown in Table 1 below.

### Example 11

Through a method substantially the same as that for preparing the solid capacitor of Example 1, the solid capacitor of Example 11 was prepared, except that the polymerizable compound is

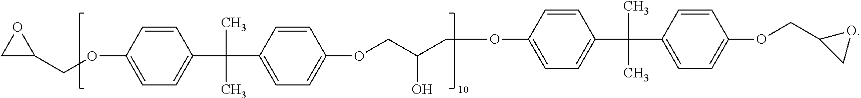

The electrical data is shown in Table 1 below.

### Example 12

Through a method substantially the same as that for preparing the solid capacitor of Example 1, the solid capacitor of Example 12 was prepared, except that the polymerizable compound is

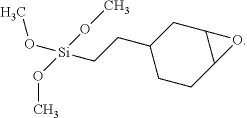 [SMILES: CO[Si](CCC1CCC2OC2C1)(OC)OC]

The electrical data is shown in Table 1 below.

### Example 13

Through a method substantially the same as that for preparing the solid capacitor of Example 1, the solid capacitor of Example 13 was prepared, except that the polymerizable compound is

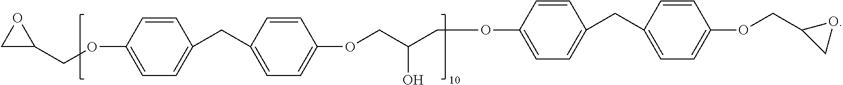

The electrical data is shown in Table 1 below.

### Example 14

Through a method substantially the same as that for preparing the solid capacitor of Example 1, the solid capacitor of Example 14 was prepared, except that the polymerizable compound is

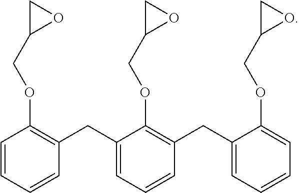 [SMILES: c1ccc(OCC2CO2)c(Cc2cccc(Cc3ccccc3OCC3CO3)c2OCC2CO2)c1]

The electrical data is shown in Table 1 below.

### Example 15

As shown in FIG. 1, a capacitor element 9 was first immersed in an electrolytic material formulation formed by mixing 30 g 3,4-ethylenedioxythiophene, 100 g tert-butanol solution containing 40% iron (III) p-toluenesulphonate, 30 g polymerizable compound

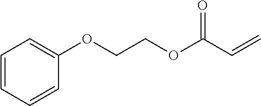

and 3 g catalyst

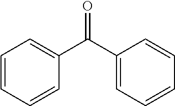 [SMILES: O=C(c1ccccc1)c1ccccc1]

for 5 min. Then, the capacitor element was taken from the electrolytic material formulation, and subjected to heat polymerization at a temperature in the range of 25° C. to 260° C., so as to form a solid electrolyte containing a mixture of a conductive polymer and a polymerizable material.

The capacitor element having the solid electrolyte was disposed in a box with a bottom, and the box was sealed with a seal element formed by an elastic substance with wires exposed, thus forming a solid capacitor.

Electrical data for the solid capacitor manufactured through the above process is shown in Table 1 below.

### Example 16

As shown in FIG. 1, a capacitor element 9 was first immersed in a first solution formed by mixing 30 g 3,4-ethylenedioxythiophene, 30 g polymerizable compound

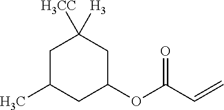

and 3 g catalyst

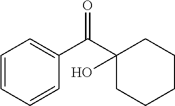 [SMILES: O=C(c1ccccc1)C1(O)CCCCC1]

for 5 min, and then immersed in a second solution of a 100 g tert-butanol solution containing 50% iron (III) p-toluenesulfonate for 5 min. Then, the capacitor element was taken from the electrolytic material formulation, and subjected to heat polymerization at a temperature in the range of 25° C. to 260° C., so as to form a solid electrolyte containing a mixture of a conductive polymer and a polymerizable material.

The capacitor element having the solid electrolyte was disposed in a box with a bottom, and the box was sealed with a seal element formed by an elastic substance with wires exposed, thus forming a solid capacitor.

Electrical data for the solid capacitor manufactured through the above process is shown in Table 1 below.

### Example 17

As shown in FIG. 1, the capacitor element 9 was first immersed in a second solution of 100 g tert-butanol solution containing 40% iron (III) p-toluenesulphonate for 5 min, and then immersed in a first solution formed by mixing 30 g 3,4-ethylenedioxythiophene and 30 g polymerizable compound

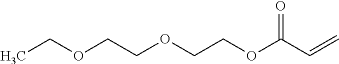

for 5 min. Then, the capacitor element was taken from the electrolytic material formulation, and subjected to heat polymerization at a temperature in the range of 25° C. to 260° C., so as to form a solid electrolyte containing a mixture of a conductive polymer and a polymerizable material.

The capacitor element having the solid electrolyte was disposed in a box with a bottom, and the box was sealed with a seal element formed by an elastic substance with wires exposed, thus forming a solid capacitor.

Electrical data for the solid capacitor manufactured through the above process is shown in Table 1 below.

### Example 18

As shown in FIG. 1, a capacitor element 9 was first immersed in a first solution containing 30 g 3,4-ethylenedioxythiophene for 5 min, and then immersed in a second solution formed by mixing 100 g tert-butanol solution containing 40% iron (III) p-toluenesulfonate, 25 g polymerizable compound

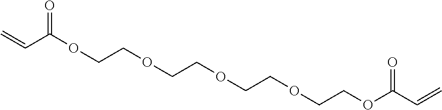 [SMILES: C=CC(=O)OCCOCCOCCOCCOC(=O)C=C]

and 3g catalyst

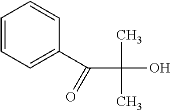

for 5 min. Then, the capacitor element was taken from the electrolytic material formulation, and subjected to heat polymerization at a temperature in the range of 25° C. to 260° C., so as to form a solid electrolyte containing a mixture of a conductive polymer and a polymerizable material.

The capacitor element having the solid electrolyte was disposed in a box with a bottom, and the box was sealed with a seal element formed by an elastic substance with wires exposed, thus forming a solid capacitor.

Electrical data for the solid capacitor manufactured through the above process is shown in Table 1 below.

### Example 19

As shown in FIG. 1, a capacitor element 9 was first immersed in a second solution formed by mixing 100 g tert-butanol solution containing 40% iron (III) p-toluenesulphonate and 30 g polymerizable compound

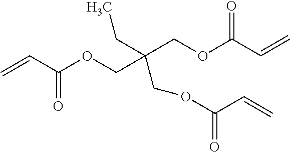 [SMILES: C=CC(=O)OCC(CC)(COC(=O)C=C)COC(=O)C=C]

for 5 min, and then immersed in a first solution containing 30 g 3,4-ethylenedioxythiophene for 5 min. Then, the capacitor element was taken from the electrolytic material formulation, and subjected to heat polymerization at a temperature in the range of 25° C. to 260° C., so as to form a solid electrolyte containing a mixture of a conductive polymer and a polymerizable material.

The capacitor element having the solid electrolyte was disposed in a box with a bottom, and the box was sealed with a seal element formed by an elastic substance with wires exposed, thus forming a solid capacitor.

Electrical data for the solid capacitor manufactured through the above process is shown in Table 1 below.

### Example 20

As shown in FIG. 1, a capacitor element 9 was immersed in an electrolytic material formulation formed by mixing 50 g pyrrole, 150 g tert-butanol solution containing 40% iron (III) p-toluenesulfonate, 30 g polymerizable compound

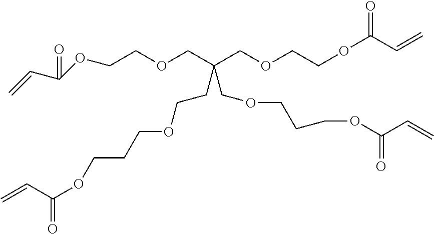 [SMILES: C=CC(=O)OCCCOCCC(COCCCOC(=O)C=C)(COCCOC(=O)C=C)COCCOC(=O)C=C]

and 3 g catalyst

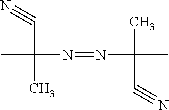

for 5 min. Then, the capacitor element was taken from the electrolytic material formulation, and subjected to heat polymerization at a temperature in the range of 25° C. to 260° C., so as to form a solid electrolyte containing a mixture of a conductive polymer and a polymerizable material.

The capacitor element having the solid electrolyte was disposed in a box with a bottom, and the box was sealed with a seal element formed by an elastic substance with wires exposed, thus forming a solid capacitor.

Electrical data for the solid capacitor manufactured through the above process is shown in Table 1 below.

### Example 21

As shown in FIG. 1, a capacitor element 9 was immersed in an electrolytic material formulation formed by mixing 50 g aniline, 150 g tert-butanol solution containing 40% iron (III) p-toluenesulphonate, 30 g polymerizable compound

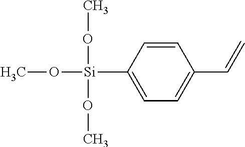

and 3 g catalyst

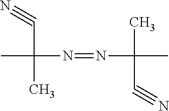

for 5 min. Then, the capacitor element was taken from the electrolytic material formulation, and subjected to heat polymerization at a temperature in the range of 25° C. to 260° C., so as to form a solid electrolyte containing a mixture of a conductive polymer and a polymerizable material.

The capacitor element having the solid electrolyte was disposed in a box with a bottom, and the box was sealed with a seal element formed by an elastic substance with wires exposed, thus forming a solid capacitor.

Electrical data for the solid capacitor manufactured through the above process is shown in Table 1 below.

### Example 22

As shown in FIG. 1, a capacitor element 9 was immersed in an electrolytic material formulation formed by mixing 30 g 3,4-ethylenedioxythiophene, 100 g tert-butanol solution containing 40% iron (III) p-toluenesulfonate and 30 g polymerizable compound

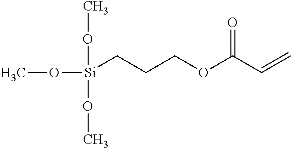

for 5 min. Then, the capacitor element was taken from the electrolytic material formulation, and subjected to heat polymerization at a temperature in the range of 25° C. to 260° C., so as to form a solid electrolyte containing a mixture of a conductive polymer and a polymerizable material.

The capacitor element having the solid electrolyte was disposed in a box with a bottom, and the box was sealed with a seal element formed by an elastic substance with wires exposed, thus forming a solid capacitor.

Electrical data for the solid capacitor manufactured through the above process is shown in Table 1 below.

### Example 23

As shown in FIG. 1, a capacitor element 9 was first immersed in a first solution formed by mixing 30 g 95% ethanol diluted 3,4-ethylenedioxythiophene, 15 g polymerizable compound

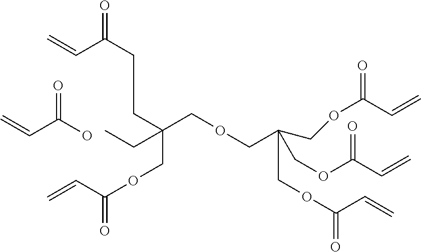

and 2 g catalyst

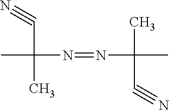

5 min, and then immersed in a second solution of 100 g n-butanol solution containing 45% iron (III) p-toluenesulphonate for 5 min. Then, the capacitor element was taken from the electrolytic material formulation, and subjected to heat polymerization at a temperature in the range of 25° C. to 260° C., so as to form a solid electrolyte containing a mixture of a conductive polymer and a polymerizable material.

The capacitor element having the solid electrolyte was disposed in a box with a bottom, and the box was sealed with a seal element formed by an elastic substance with wires exposed, thus forming a solid capacitor.

Electrical data for the solid capacitor manufactured through the above process is shown in Table 1 below.

### Example 24

Through a method substantially the same as that for preparing the solid capacitor of Example 15, the solid capacitor of Example 24 was prepared, except that the polymerizable compound is

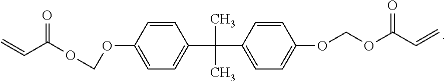 [SMILES: C=CC(=O)OCOc1ccc(C(C)(C)c2ccc(OCOC(=O)C=C)cc2)cc1]

The electrical data is shown in Table 1 below.

### Example 25

Through a method substantially the same as that for preparing the solid capacitor of Example 15, the solid capacitor of Example 25 was prepared, except that the polymerizable compound is composed of 5 g

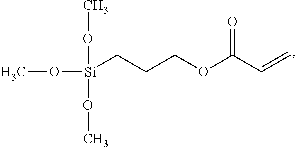

15 g

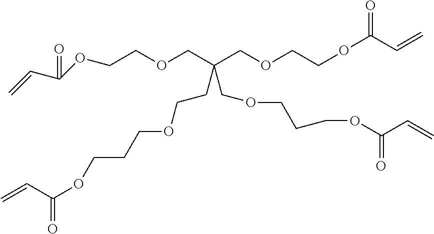 [SMILES: C=CC(=O)OCCCOCCC(COCCCOC(=O)C=C)(COCCOC(=O)C=C)COCCOC(=O)C=C]

and 10 g

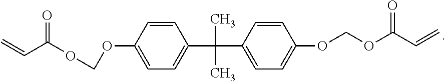 [SMILES: C=CC(=O)OCOc1ccc(C(C)(C)c2ccc(OCOC(=O)C=C)cc2)cc1]

The electrical data is shown in Table 1 below.

### Comparative Example 1

A capacitor element 9 shown in FIG. 1 was immersed in an electrolytic material formulation formed by mixing 10 g 3,4-ethylenedioxythiophene and 100 g tert-butanol solution containing 40% iron (III) p-toluenesulphonate for 5 min. Then, the capacitor element was taken from the electrolytic material formulation, and subjected to heat polymerization at a temperature in the range of 25° C. to 260° C., to form a solid electrolyte. The capacitor element having the solid electrolyte was disposed in a box with a bottom, and the box was sealed with a seal element formed by an elastic substance with wires exposed, thus forming a solid capacitor. Electrical data for the solid capacitor manufactured through the above process is shown in Table 1 below.

TABLE 1

| | Capacitance | | Equivalent | | |
|---|---|---|---|---|---|
| | for | | Series | Spark | |
| | Storage | Dissipation | Resistance | Voltage | |
| | (CS) | Factor | (ESR) | (Withstand | Reproducibility |
| | (μF, 120 Hz) | (DF) | (mohm) | Voltage) | (%) |
| Example 1 | 902 | 0.019 | 8.1 | 21.0 | 100.0 |
| Example 2 | 916 | 0.024 | 8.5 | 21.0 | 100.0 |
| Example 3 | 910 | 0.026 | 9.1 | 22.0 | 94.0 |
| Example 4 | 912 | 0.026 | 8.6 | 21.0 | 100.0 |
| Example 5 | 898 | 0.025 | 10.1 | 22.0 | 100.0 |
| Example 6 | 907 | 0.037 | 8.5 | 22.0 | 100.0 |
| Example 7 | 917 | 0.037 | 9.3 | 23.0 | 100.0 |
| Example 8 | 917 | 0.083 | 13.0 | 24.0 | 100.0 |
| Example 9 | 895 | 0.040 | 13.0 | 24.0 | 100.0 |
| Example 10 | 910 | 0.039 | 8.5 | 21.0 | 94.0 |
| Example 11 | 899 | 0.038 | 8.3 | 21.0 | 94.0 |
| Example 12 | 880 | 0.040 | 13.0 | 23.0 | 100.0 |
| Example 13 | 913 | 0.039 | 14.0 | 23.0 | 100.0 |
| Example 14 | 970 | 0.050 | 14.0 | 22.0 | 100.0 |
| Example 15 | 1056 | 0.022 | 8.1 | 23.0 | 88.0 |
| Example 16 | 1075 | 0.024 | 9.5 | 23.0 | 94.0 |
| Example 17 | 1066 | 0.023 | 9.5 | 21.0 | 100.0 |
| Example 18 | 1069 | 0.023 | 9.5 | 22.0 | 100.0 |
| Example 19 | 1070 | 0.023 | 9.5 | 25.0 | 100.0 |
| Example 20 | 1039 | 0.029 | 12 | 25.0 | 100.0 |
| Example 21 | 1064 | 0.022 | 9.1 | 23.0 | 100.0 |
| Example 22 | 1066 | 0.021 | 8.3 | 24.0 | 100.0 |
| Example 23 | 1091 | 0.047 | 12 | 24.0 | 100.0 |
| Example 24 | 1054 | 0.036 | 14.2 | 24.0 | 100.0 |
| Example 25 | 54 | 0.0190 | 19.1 | 73.0 | 94.0 |
| Comparative | 677 | 0.032 | 9.4 | 20.0 | 62.5 |
| Example 1 | | | | | |

Conditions for the electrical tests in Table 1 are as follows:

| Item | Condition |
|---|---|
| Spark voltage (V) | room temperature, 0.5 to 1.0 mA |
| Dissipation factor (DF) | 120Hz/120° C. |
| Equivalent series resistance (ESR) | 100 kHz to 300 kHz/20° C. |
| Reproducibility | among 16 samples from an Example or the |
| | Comparative Example, a ratio |
| | that electrical data |
| | for each item falls within |
| | 20% variation range of |
| | an average value |

The service life test of the solid capacitors manufactured is shown in Table 2 below.

TABLE 2

| | | | Equivalent | Pass Rate |
|---|---|---|---|---|
| | Capacitance | | Series | of |
| | for Storage | Dissipation | Resistance | Service |
| | (CS) | Factor | (ESR) | Life Test |
| | (μF, 120 Hz) | (DF) | (mohm) | (%) |
| Example 1 | 869 | 0.035 | 9.5 | 100.0 |
| Example 2 | 882 | 0.032 | 8.8 | 100.0 |
| Example 3 | 876 | 0.032 | 8.6 | 100.0 |
| Example 4 | 877 | 0.035 | 9.6 | 100.0 |
| Example 5 | 862 | 0.031 | 8.7 | 100.0 |
| Example 6 | 873 | 0.032 | 9.2 | 100.0 |
| Example 7 | 884 | 0.031 | 8.6 | 100.0 |
| Example 8 | 884 | 0.030 | 14.0 | 100.0 |
| Example 9 | 860 | 0.031 | 14.2 | 100.0 |
| Example 10 | 876 | 0.031 | 8.8 | 100.0 |
| Example 11 | 869 | 0.042 | 8.7 | 100.0 |
| Example 12 | 852 | 0.048 | 14.1 | 100.0 |
| Example 13 | 880 | 0.045 | 15.8 | 100.0 |
| Example 14 | 936 | 0.055 | 14.7 | 100.0 |
| Example 15 | 1016 | 0.032 | 8.4 | 100.0 |
| Example 16 | 1038 | 0.035 | 9.9 | 100.0 |
| Example 17 | 1034 | 0.033 | 9.7 | 100.0 |
| Example 18 | 1029 | 0.033 | 9.7 | 100.0 |
| Example 19 | 1035 | 0.032 | 9.8 | 100.0 |
| Example 20 | 997 | 0.037 | 12.6 | 100.0 |
| Example 21 | 1032 | 0.029 | 9.5 | 100.0 |
| Example 22 | 1034 | 0.031 | 9.3 | 100.0 |
| Example 23 | 1036 | 0.057 | 12.4 | 100.0 |
| Example 24 | 1016 | 0.046 | 14.7 | 100.0 |
| Example 25 | 52 | 0.022 | 21.7 | 100.0 |
| Comparative | 580 | 0.049 | 12.2 | 20.0 |
| Example 1 | | | | |

Conditions for the service life test in Table 2 are as follows:

Generally, conditions for service life of a solid capacitor include, at 105° C., after being placed for 2000 hr, the solid capacitor is tested to determine whether the properties still meet the specifications.

It can be seen from Table 1 and Table 2 that, a solid electrolyte according to the present invention is applied to a solid capacitor, due to the existence of a curable polymer, the capacitance and the voltage resistance can be improved, and the service life can be prolonged.

A conductive polymer is mixed with a curable polymer, so that the conductive polymer can be adhered on an electrode, and the stability of the conductive polymer is improved, that is, the polymer obtained through polymerization has good physical properties. As a result, the yield of the process is high, the service life is long, and the working voltage is high. Therefore, the polymer can be widely used in industries requiring high-voltage capacitors, for example, drive power supplies for LED lamps, electronic energy-saving lamps, and rectifiers, motor electronic devices, computer motherboards, frequency converters, network communications, power supplies for medical devices, and other high-end areas.

What is claimed is:

1. An electrolytic material formulation, comprising:
(a1) a conductive compound;
(b1) an oxidant; and
(c1) a polymerizable compound.

2. The electrolytic material formulation according to claim 1, wherein the conductive compound is selected from the group consisting of pyrrole, thiophene, aniline, phenylene sulfide, and derivatives thereof.

3. The electrolytic material formulation according to claim 1, wherein the oxidant is selected from the group consisting of alkali metal persulfates, ammonium persulfate, ferric salts of organic acids, and inorganic acids with an organic group

4. The electrolytic material formulation according to claim 1, wherein the polymerizable compound comprises an epoxy group-containing polymerizable compound, a vinyl-containing unsaturated polymerizable compound, an acrylate-containing unsaturated polymerizable compound, or a mixture thereof.

5. The electrolytic material formulation according to claim 1, wherein the polymerizable compound is selected from the group consisting of: 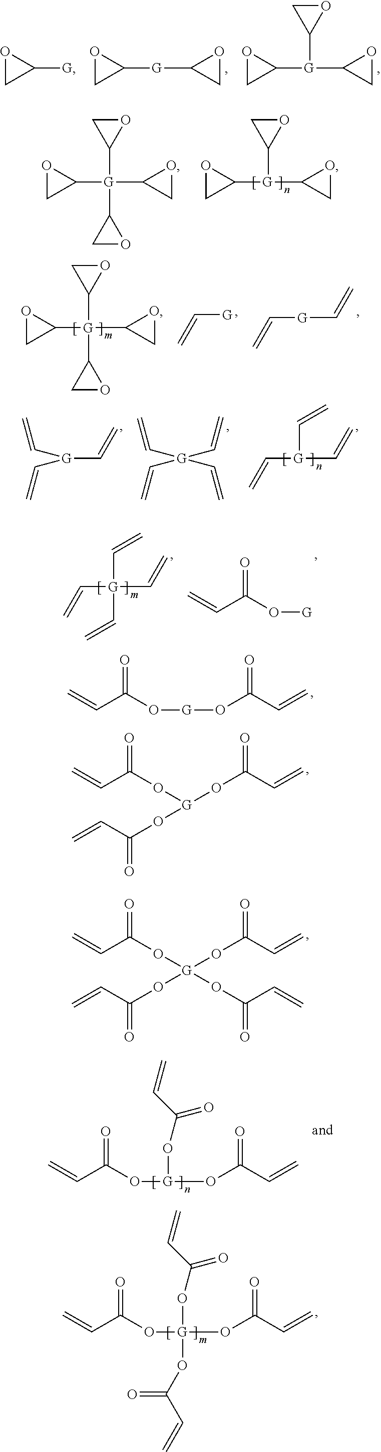
wherein n is an integer greater than or equal to 3, m is an integer greater than or equal to 2, and G is an organic group, an inorganic group, or a mixture thereof.

6. The electrolytic material formulation according to claim 5, wherein the polymerizable compound is selected from the group consisting of:

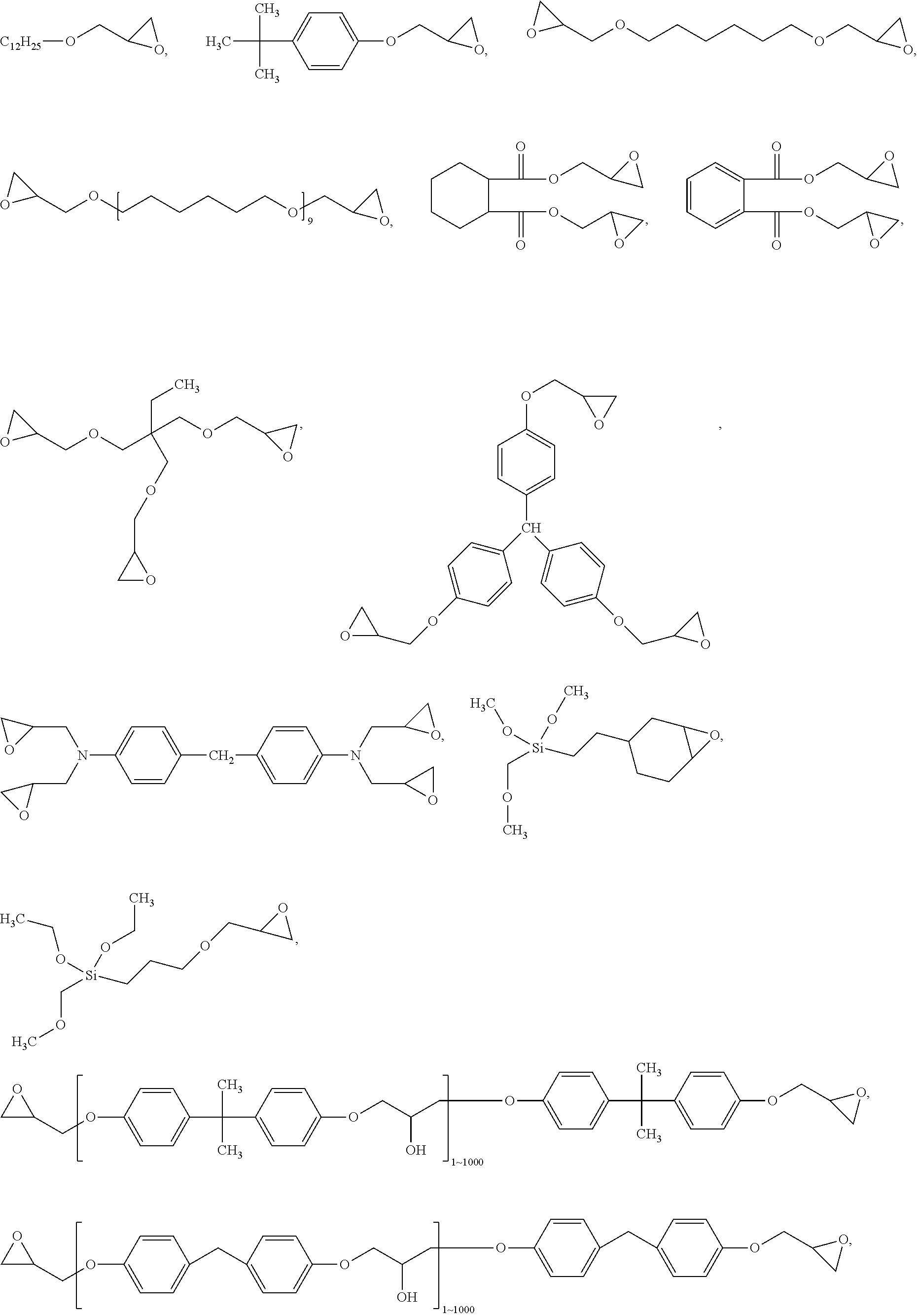

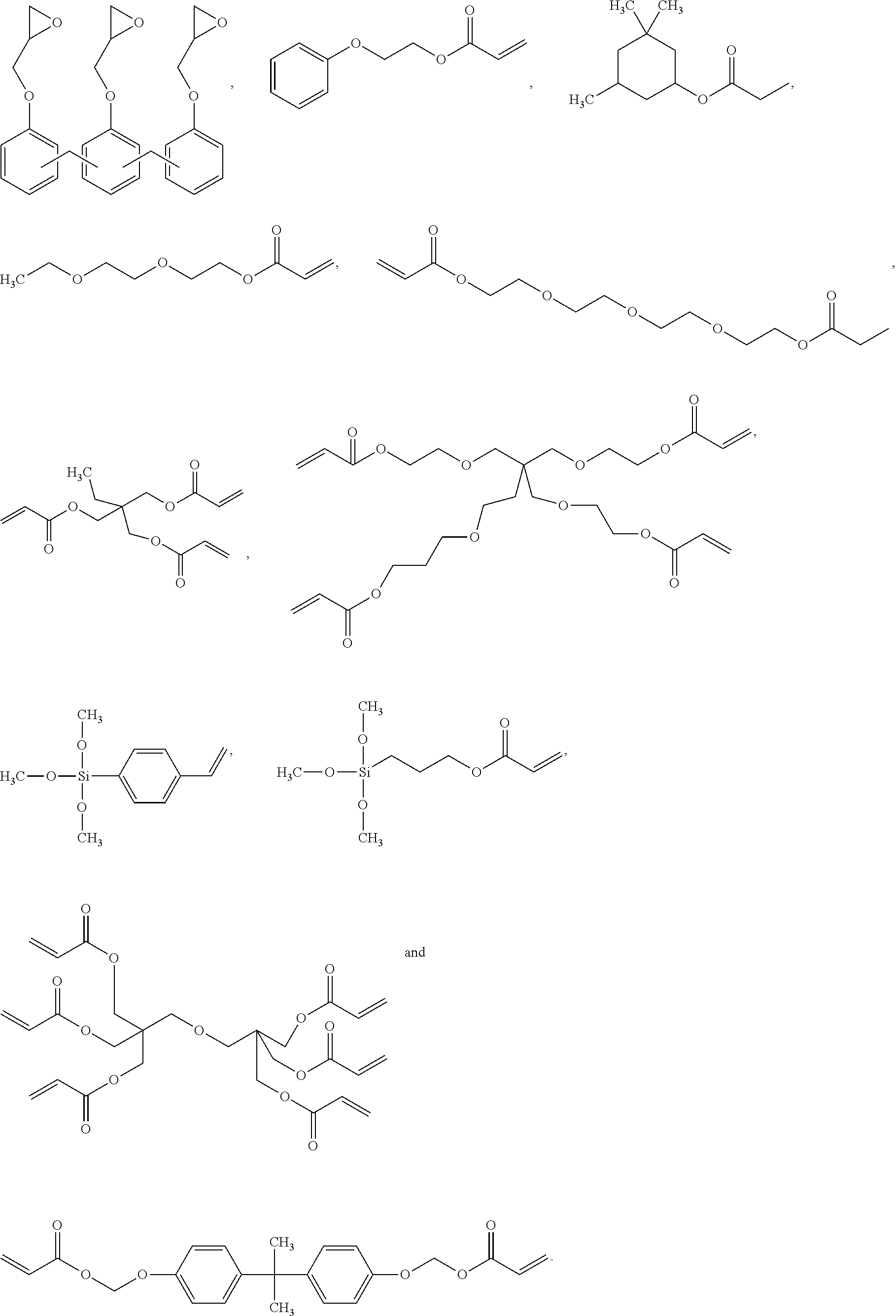

7. The electrolytic material formulation according to claim 1, wherein the molecular weight of the polymerizable compound is in the range from 40 to 1,000,000.

8. The electrolytic material formulation according to claim 1, wherein the amount of the component (b1) is 1-10000 parts by weight, and the amount of the component (c1) is 0.1-10000 parts by weight, based on 100 parts by weight of the component (a1).

9. The electrolytic material formulation according to claim 8, wherein the amount of the component (b1) is 10-2000 parts by weight, and the amount of the component (c1) is 1-3000 parts by weight, based on 100 parts by weight of the component (a1).

10. The electrolytic material formulation according to claim 1, further comprising a curing agent, wherein the curing agent is an amine or an acid anhydride.

11. The electrolytic material formulation according to claim 10, wherein the curing agent is

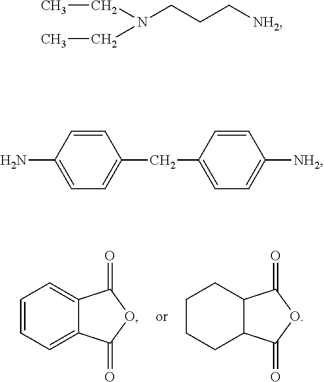

12. An electrolytic material composition, formed from the electrolytic material formulation according to claim 1 through polymerization.

13. The electrolytic material composition according to claim 12, comprising:
(A) a first polymer, formed from the polymerization units derived the conductive compound and the oxidant; and
(B) a second polymer, formed from the polymerization units derived from the polymerizable compound.

14. The electrolytic material composition according to claim 13, wherein the second polymer is formed from the polymerization units derived from the polymerizable compound and a curing agent.

15. A solid capacitor, comprising:
an anode;
a dielectric layer formed on the anode;
a cathode; and
a solid electrolyte located between the dielectric layer and the cathode, wherein the solid electrolyte comprises the electrolytic material composition according to claim 12.
